(19) United States
(12) Patent Application Publication
(10) Pub. No.: US 2009/0241020 A1
(43) Pub. Date: Sep. 24, 2009

(54) Method and Related Apparatus and Website Access System Capable of Enhancing Website Compatibility

(76) Inventor: Yu-Hsia Hsiao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/392,079

(22) Filed: Feb. 24, 2009

(30) Foreign Application Priority Data
Mar. 24, 2008 (TW) 097110396

(51) Int. Cl. G06F 17/00

(52) U.S. Cl. 715/239

(57) ABSTRACT

A method capable of enhancing website compatibility includes receiving a command for browsing a first website stored in a website server through a website browser, receiving a first program code of the first website according to the command, determining whether the first program code is capable of being interpreted by the website browser, so as to generate a determination result, transforming the first program code according to the determination result, and outputting a transformation result of the first program code to the website browser.

### BACKGROUND OF THE INVENTION

1. Field of the Invention

The present invention relates to a method and related apparatus and website access system capable of enhancing website compatibility, and more particularly, to a method and related apparatus and website access system capable of taking off workload of a website designer, enhancing developing efficiency, and reducing debugging difficulty.

2. Description of the Prior Art

Internet technology accelerates information acquisition, so that a user can browse a website to receive e-mail, search information, or read news. Typically, the user may input a web address into a website browser for browsing a corresponding website, so as to display contents of the website. The common website browsers, such as IE, Firefox, and Opera, browse websites through interpreting program codes of the websites. However, various browsers may not support a specific website language, such that a website designer must design different program codes corresponding to the languages. As a result, a simple program may become redundant and complicated, increasing the designer's workload.

For example, in JavaScript, IE supports an object ActiveXObject but not support an object XMLHttpRequest, while another website browser may support the object XMLHttpRequest but not support the object ActiveXObject. Therefore, the website designer needs to list all the possible situations, and determines which website browser is used by the user at first, so as to load the correct program code to ensure accurately opening the corresponding website.

In short, in the prior art, the website designer needs to consider that different website browsers may support different languages. Therefore, to achieve the same website effect, the website designer may develop at least one set of website program codes. Besides, the website designer may not completely realize which language is supported or not supported by each browser. In case an incompatible issue is found after the website design is completed, the website designer needs to find out incompatible program codes, and figures out substitution, causing degradation of developing efficiency, and difficulty of debugging.

### SUMMARY OF THE INVENTION

It is therefore a primary objective of the claimed invention to provide a method and related apparatus and website access system capable of enhancing website compatibility.

The present invention discloses a method capable of enhancing website compatibility, which includes receiving a command outputted from a user end via a website browser for browsing a first website stored in a website server, receiving a first program code of the first website according to the command, determining whether the first program code is capable of being interpreted by the website browser so as to generate a determination result, transforming the first program code according to the determination result, and outputting a transformation result of the first program code to the website browser.

The present invention further discloses an electronic device capable of enhancing website compatibility, which includes a user interface coupled to a user end, a server interface coupled to a website server, a command reception unit coupled to the user interface for receiving a command outputted from the user end via a website browser for browsing a first website stored in the website server, a reading unit coupled to the command reception unit and the server interface for receiving a first program code of the first website from the website server via the server interface according to the command, a determination unit coupled to the command reception unit and the reading unit for determining whether the first program code is capable of being interpreted by the website browser so as to generate a determination result, a transformation unit coupled to the determination unit and the reading unit for transforming the first program code according to the determination result, and an output unit coupled to the transformation unit and the user interface for outputting a transformation result of the first program code to the website browser.

The present invention further discloses a website accessing system capable of enhancing website compatibility, which includes a website server for storing website program codes compiled by a specific language, a plurality of user equipments for reading the website program codes stored in the website server through a website browser respectively, and a browser transformation unit. The browser transformation unit includes a user interface coupled to the plurality of user equipments, a server interface coupled to the website server, a command reception unit coupled to the user interface for receiving a command outputted from a first user equipment of the plurality of user equipments via a corresponding website browser for browsing a first website stored in the website server, a reading unit coupled to the command reception unit and the server interface for receiving a first program code of the first website from the website server via the server interface according to the command, a determination unit coupled to the command reception unit and the reading unit for determining whether the first program code is capable of being interpreted by the website browser used by the first user end equipment, so as to generate a determination result, a transformation unit coupled to the determination unit and the reading unit for transforming the first program code according to the determination result, and an output unit coupled to the transformation unit and the user interface for outputting a transformation result of the first program code to the first user equipment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a process according to an embodiment of the present invention.

FIG. 2 is a schematic diagram of a JavaScript transformation table according to an embodiment of the present invention.

FIG. 3 is a schematic diagram of a website access system according to an embodiment of the present invention.

FIG. 4 is a schematic diagram of a browser transformation unit shown in FIG. 3 according to a preferred embodiment of the present invention.

### DETAILED DESCRIPTION

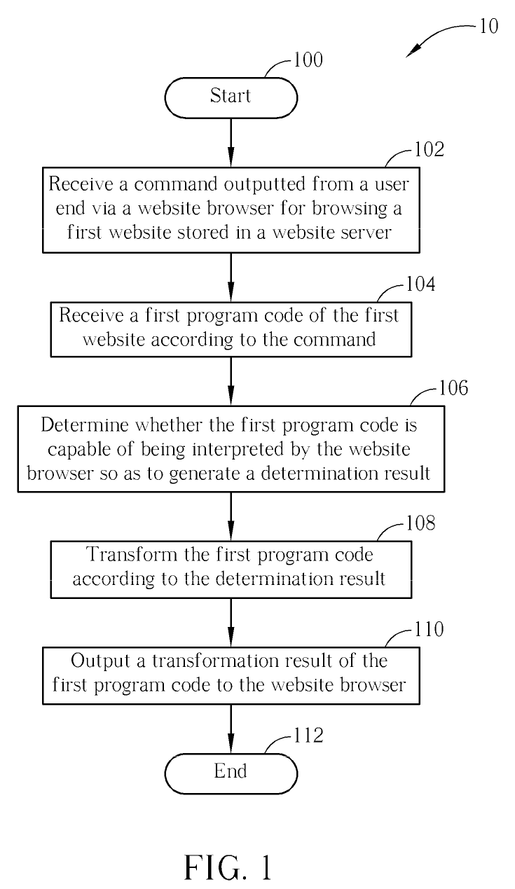

Please refer to FIG. 1. FIG. 1 is a schematic diagram of a process 10 according to an embodiment of the present invention. The process 10 is utilized for enhancing website compatibility, which comprises the following steps:

Step 100: Start.

Step 102: Receive a command outputted from a user end via a website browser for browsing a first website stored in a website server.

Step 104: Receive a first program code of the first website according to the command.

Step 106: Determine whether the first program code is capable of being interpreted by the website browser, so as to generate a determination result.

Step 108: Transform the first program code according to the determination result.

Step 110: Output a transformation result of the first program code to the website browser

Step 112: End.

According to the process 10, when the user end browses a website via a website browser, the present invention first determines whether a program code corresponding to the website is capable of being interpreted by the website browser, and transforms the program code of the website accordingly. In other words, when a user browses a website, the present invention first determines whether a website browser utilized by the user supports a language of a program code of the website. Preferably, when the website browser utilized by the user does not support the language of the program code of the website, the present invention transforms the current program code into a proper program code in order to conform to the website browser utilized by the user. On the contrary, when the website browser utilized by the user supports the language of the program code of the website, the present invention directly outputs the program code without performing transformation.

Therefore, via the process 10, if a program code of a website is not capable of being interpreted by the corresponding website browser, the present invention transforms the program code into a program code capable of being interpreted by the website browser. In such a condition, the website designer only needs to develop a website program code based on a specified language, and does not need to consider all the possible languages support by different browsers. As a result, the present invention can take off workload, enhance developing efficiency, and reduce debugging difficulty.

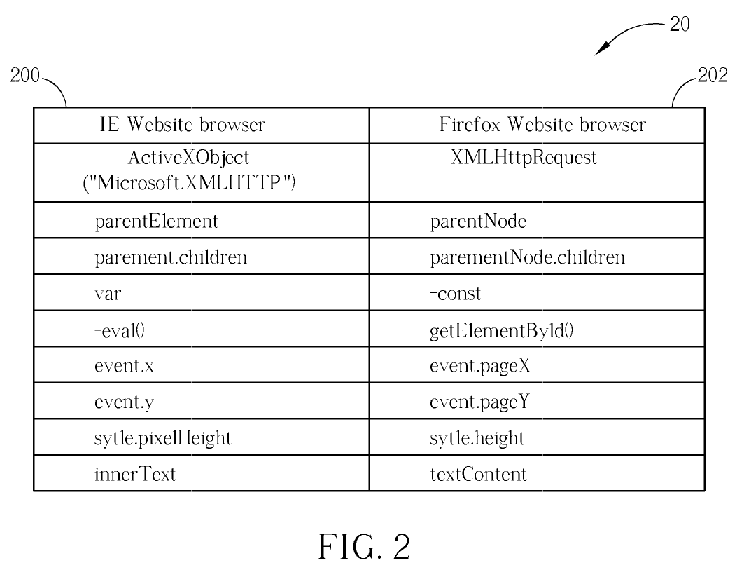

Note that, in the present invention, the website program code can conform to Java language or other languages, and is not limited. Furthermore, the present invention can preset a transformation table or a query table for providing rapid transformation for different languages. For example, please refer to FIG. 2. FIG. 2 is a schematic diagram of a JavaScript transformation table 20 according to an embodiment of the present invention. The JavaScript transformation table 20 includes a first column 200 and a second column 202. The first column 200 is corresponding to objects supported by IE, while the second column 202 is corresponding to objects supported by Firefox. Objects in the same row generate the same website effect. In such a condition, the present invention can transform program codes of websites stored in a server into a format corresponding to a website browser utilized by a user. In FIG. 2, ‘-’ represents one way transformation, e.g. an object eval( ) only supports transformation from IE to Firefox, but not support transformation from Firefox to IE.

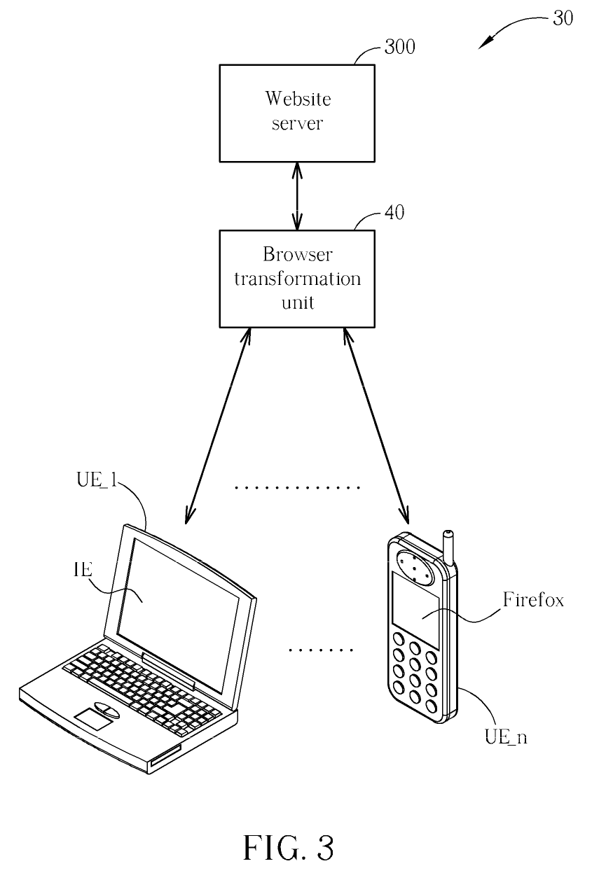

As for the realization of the process 10, please refer to FIG. 3. FIG. 3 is a schematic diagram of a website access system 30 according to an embodiment of the present invention. The website access system 30 includes a website server 300, a browser transformation unit 40, and user equipments UE_1˜UE_n. The website server 300 is utilized for storing website program codes compiled by a specific language. The user equipments UE_1˜UE_n can be notebooks, desktops, PDAs, smart phones, and so on, utilized for reading the website program codes stored in the website server 300 through corresponding website browsers. The browser transformation unit 40 is utilized for realizing the process 10. When the user equipments UE_1˜UE_n read the website program codes stored in the website server 300, the browser transformation unit 40 transforms the program codes into proper program codes according to types of website browsers used by the user equipments UE_1˜UE_n. For example, suppose the website program codes stored in the website server 300 conform to IE format, and the user equipment UE_1 uses IE while the user equipment UE_n uses Firefox. When the user equipment UE_1 reads the program codes stored in the website server 300, the browser transformation unit 40 directly outputs the program codes to the user equipment UE_1 without transformation. When the user equipment UE_n reads the program codes stored in the website server 300, the browser transformation unit 40 transforms the program codes into Firefox format, so that the user equipment UE_1 can correctly read the program codes. In such a situation, the website designer can develop the program codes based on a specific language supported by the website browser (IE in this embodiment), and does not need to consider all the possible languages. As a result, the present invention can take off workload of the website designer, enhance developing efficiency, and reduce difficulty of debugging.

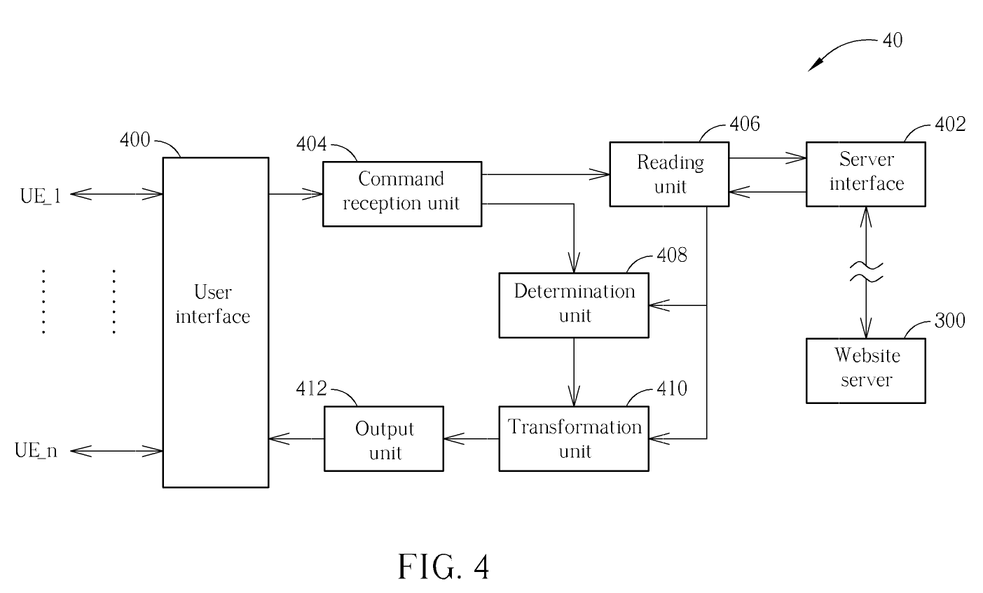

Please refer to FIG. 4. FIG. 4 is a schematic diagram of a browser transformation unit 40 shown in FIG. 3 according to a preferred embodiment of the present invention. The browser transformation unit 40 can be integrated in the website server 300, and includes a user interface 400, a server interface 402, a command reception unit 404, a reading unit 406, a determination unit 408, a transformation unit 410, and an output unit 41 2. The user interface 400 is coupled to user equipments UE_1˜UE_n for exchanging data with the user equipments UE_1˜UE_n. The server interface 402 is coupled to the website server 300 for exchanging data with the website server 300. The command reception unit 404 is coupled to the user interface 400, and utilized for receiving a command outputted from one of the user equipments UE_1˜UE_n via the corresponding website browser, in order to browse a first website stored in the website server 300. The reading unit 406 is coupled to the command reception unit 404 and the server interface 406, and utilized for receiving a first program code of the first website from the website server 300 via the server interface 402 according to the command. The determination unit 408 is coupled to the command reception unit 404 and the reading unit 406, and utilized for determining whether the first program code is capable of being interpreted by the website browser, so as to generate a determination result. The transformation unit 410 is coupled to the determination unit 408 and the reading unit 406, and utilized for transforming the first program code according to the determination result. The output unit 412 is coupled to the transformation unit 410 and the user interface 400, and utilized for outputting a transformation result of the first program code to the corresponding user equipment.

Thus, via the browser transformation unit 40, when the command reception unit 404 receives a command for browsing a website from a user via the user interface 400, the reading unit 406 can read data stored in the website server 300. Meanwhile, the determination unit 408 determines whether a type of a website browser utilized by the user supports a language of a program code of the website. Preferably, when the website browser utilized by the user does not support the language of the program code of the website, the transformation unit 410 transforms the current program code into a proper program code conforming to the website browser. On the contrary, when the website browser utilized by the user supports the language of the program code of the website, the transformation unit 410 directly outputs the program code to the user without transformation.

On the other hand, in the browser transformation unit 40, the present invention can further preset a transformation table or a query table such as the JavaScript transformation table 20 shown in FIG. 2, to provide rapid transformation of the transformation unit 410 for languages supported by different web browsers.

In summary, when a program code of a website is not capable of being interpreted by a corresponding website browser, the present invention can transform the program code into a program code capable of being interpreted by the website browser. In such a condition, the website designer only needs to develop the website program codes based on a specified language, and does not need to consider all the possible languages supported by different browsers. As a result, the present invention can take off workload of the website designer, enhance developing efficiency, and reduce debugging difficulty.

Those skilled in the art will readily observe that numerous modifications and alterations of the device and method may be made while retaining the teachings of the invention.

What is claimed is:

1. A method capable of enhancing website compatibility comprising:
receiving a command outputted from a user end via a website browser for browsing a first website stored in a website server;
receiving a first program code of the first website according to the command;
determining whether the first program code is capable of being interpreted by the website browser, so as to generate a determination result;
transforming the first program code according to the determination result; and
outputting a transformation result of the first program code to the website browser.

2. The method of claim 1, wherein receiving the command outputted from the user end via the website browser comprises determining a type of the website browser.

3. The method of claim 1, wherein transforming the first program code according to the determination result is transforming the first program code into a second program code capable of being interpreted by the website browser when the determination result indicates that the first program code is not capable of being interpreted by the website browser.

4. The method of claim 1, wherein transforming the first program code according to the determination result is outputting the first program code when the determination result indicates that the first program code is capable of being interpreted by the website browser.

5. The method of claim 1, wherein the first program code conforms to Java language.

6. An electronic device capable of enhancing website compatibility comprising:
a user interface coupled to a user end;
a server interface coupled to a website server;
a command reception unit coupled to the user interface, for receiving a command outputted from the user end via a website browser for browsing a first website stored in the website server;
a reading unit coupled to the command reception unit and the server interface, for receiving a first program code of the first website from the website server via the server interface according to the command;
a determination unit coupled to the command reception unit and the reading unit, for determining whether the first program code is capable of being interpreted by the website browser, so as to generate a determination result;
a transformation unit coupled to the determination unit and the reading unit, for transforming the first program code according to the determination result; and
an output unit coupled to the transformation unit and the user interface, for outputting a transformation result of the first program code to the website browser.

7. The electronic device of claim 6, wherein the command reception unit is further utilized for determining a type of the website browser.

8. The electronic device of claim 6, wherein the determination unit transforms the first program code into a second program code capable of being interpreted by the website browser when the determination result indicates that the first program code is not capable of being interpreted by the website browser.

9. The electronic device of claim 6, wherein the determination unit outputs the first program code when the determination result indicates that the first program code is capable of being interpreted by the website browser.

10. The electronic device of claim 6, wherein the first program code conforms to Java language.

11. The electronic device of claim 6 being integrated in the website server.

12. A website access system capable of enhancing website compatibility comprising:
a website server for storing website program codes compiled by a specific language;
a plurality of user equipments for reading the website program codes stored in the website server through a website browser respectively; and
a browser transformation unit comprising:
a user interface coupled to the plurality of user equipments;
a server interface coupled to the website server;
a command reception unit coupled to the user interface, for receiving a command outputted from a first user equipment of the plurality of user equipments via a corresponding website browser for browsing a first website stored in the website server;
a reading unit coupled to the command reception unit and the server interface, for receiving a first program code of the first website from the website server via the server interface according to the command;
a determination unit coupled to the command reception unit and the reading unit, for determining whether the first program code is capable of being interpreted by the website browser used by the first user end equipment, so as to generate a determination result;
a transformation unit coupled to the determination unit and the reading unit, for transforming the first program code according to the determination result; and
an output unit coupled to the transformation unit and the user interface, for outputting a transformation result of the first program code to the first user equipment.

13. The website access system of claim 12, wherein the command reception unit is further utilized for determining a type of the website browser.

14. The website access system of claim 12, wherein the determination unit transforms the first program code into a second program code capable of being interpreted by the first user end equipment when the determination result indicates that the first program code is not capable of being interpreted by the first user end equipment.

15. The website access system of claim 12, wherein the determination unit outputs the first program code when the determination result indicates that the first program code is capable of being interpreted by the first user end equipment.

16. The website access system of claim 12, wherein the first program code conforms to Java language.

17. The website access system of claim 12 being integrated in the website server.
